(19) United States
(12) Patent Application Publication
(10) Pub. No.: US 2015/0073796 A1
(43) Pub. Date: Mar. 12, 2015

(54) APPARATUS AND METHOD OF GENERATING LANGUAGE MODEL FOR SPEECH RECOGNITION

(71) Applicant: Electronics and Telecommunications Research Institute, Daejeon (KR)

(72) Inventors: Jeong-Se Kim, Daejeon (KR); Sang-Hun Kim, Daejeon (KR)

(73) Assignee: Electronics and Telecommunications Research Institute, Daejeon (KR)

(21) Appl. No.: 14/243,079

(22) Filed: Apr. 2, 2014

(30) Foreign Application Priority Data
Sep. 12, 2013 (KR) 10-2013-0109428

(51) Int. Cl. G10L 15/18; G10L 15/06

(52) U.S. Cl. CPC G10L 15/18; G10L 15/063
USPC 704/244

(57) ABSTRACT

Disclosed herein are an apparatus and a method of generating a language model for speech recognition. The present invention is to provide an apparatus of generating a language model capable of improving speech recognition performance by predicting a position at which break is present and reflecting the predicted break information.

### CROSS REFERENCE TO RELATED APPLICATION

This application claims the benefit of Korean Patent Application No. 10-2013-0109428, filed on Sep. 12, 2013, entitled “Apparatus and Method of Generating Language Model for Speech recognition”, which is hereby incorporated by reference in its entirety into this application.

### BACKGROUND OF THE INVENTION

1. Technical Field

The present invention relates to a method of generating a language model, and more particularly, to a method of generating a language model in which break information is reflected in continuous speech recognition.

2. Description of the Related Art

Break information, which extracts a unit of a break, means a section in which a speaker instantaneously stops speaking in order for him/her to breathe in when he/she speaks and is represented by a pause signal. In a speech synthesizing method, research into a break processing technology for improving naturalness and understanding of a synthetic speech has been conducted.

Meanwhile, a speech recognition method is divided into several methods depending on a form of utterance. As a typical speech recognizing method, methods such as an isolated word recognition method, a connected word recognition method, a continuous speech recognition method, a keyword spotting method, and the like, have been known. Among them, unlike the isolated word recognition method of recognizing individual words, in the continuous speech recognition method of searching a corresponding text or a continuous word stream corresponding to a speech signal, as the number of words of a vocabulary dictionary is increased, the number of word streams configuring a text is significantly increased, and as the number of words is increased, a probability that words will be erroneously recognized as words having a similar pronunciation is increased due to a pronunciation variation between the words.

A language model in the speech recognition indicates a model built by collecting connectivity between words in a statistical method from a text corpus so that a text uttered by a user is recognized as a correct text. As the language model, a uni-gram (1-gram), a bi-gram (2-gram), and a tri-gram (3-gram) are mainly used. In the uni-gram, which uses a probability of a word, an immediately previously positioned past word is not used. The bi-gram and the tri-gram use a probability that depends on immediately previous one word and two words, respectively. The use of the language model as described above allows a grammatically valid word stream to be recognized and minimizes a search space of a word or a text, thereby making it possible to improve recognition performance and decrease a search time.

According to the related art, in order to generate a general language model, a recognition unit is selected, and a language model tool corresponding to the selected recognition unit is created and used to generate the language model.

In addition, a speech recognizer according to the related art using the above-mentioned language model optionally processes whether or not a silent syllable is present between words. That is, when a speech recognition engine performs decoding, it calculates both of the case in which a silent section is present and the case in which the silent section is not present to determine a recognized text depending on a final score. However, in the above-mentioned scheme, when whether or not the silent syllable is present is statistically determined, the case in which the silent section is recognized as a speech section or the speech section is recognized as the silent section is frequently generated. Therefore, an actual speech recognition engine shows the best performance when it performs processing on the assumption that the silent syllable is not present between all speaking syllables rather than optionally processing the silent syllable. Therefore, most of the speech recognition engines have performed speech recognition on the assumption that the silent syllable is not present. However, in this case, the speech recognition engines may not process the case in which the silent syllable is present, such that a sacrifice of performance cannot but be made.

### SUMMARY OF THE INVENTION

An object of the present invention is to provide an apparatus of generating a language model capable of improving speech recognition performance by predicting a position at which break is present and reflecting the predicted break information.

Another object of the present invention is to provide a method of generating a language model.

According to an exemplary embodiment of the present invention, there is provided an apparatus of generating a language model, including: a text corpus in which a plurality of texts collected in advance for speech recognition are stored; a recognition unit divider obtaining at least one of the plurality of texts from the text corpus and dividing the obtained text in a preset recognition unit; a syntax analyzer analyzing a syntax of the text divided in the recognition unit; a break rule database in which a plurality of break rules set based on a preset break rule for speech synthesis are pre-stored; a break inserter searching and obtaining a corresponding break rule among the plurality of break rules using the syntax analyzed by the syntax analyzer and inserting a preset break mark into the text divided in the recognition unit depending on the obtained break rule; a language model database in which language models are stored; and a language model generator receiving the text into which the break mark is inserted by the break inserter, generating the received text as a language model in a preset scheme, and storing the generated language model in the language model database.

The break rule database may store a break rule in which a probability at which a speaker actually performs a break is equal to or higher than a reference break probability experimentally set among the plurality of break rules set based on the preset break rule for the speech synthesis.

The language model generator may convert both of the text into which the break mark is inserted and the text divided in the recognition unit into the language model and store the language model in the language model database.

The language model generator may store the break mark and a preset number of words before and after the break mark in the text into which the break mark is inserted and the text divided in the recognition unit in the language model database.

The language model generator may include: a first language model generator receiving the text divided in the recognition unit from the recognition unit divider and generating a first language model; a second language model generator receiving the text into which the break mark is inserted from the break inserter and generating a second language model; and an interpolator interpolating the first and second language models to generate the language model and storing the generated language model in the language model database.

According to another exemplary embodiment of the present invention, there is provided a method of generating a language model by an apparatus of generating a language model including a text corpus in which a plurality of texts collected in advance for speech recognition are stored and a break rule database in which a plurality of break rules set based on a preset break rule for speech synthesis are pre-stored, including: obtaining at least one of the plurality of texts from the text corpus; dividing the obtained text in a preset recognition unit; analyzing a syntax of the text divided in the recognition unit and searching and obtaining a corresponding break rule among the plurality of break rules using the analyzed syntax; inserting a preset break mark into the text divided in the recognition unit depending on the obtained break rule; generating the text into which the break mark is inserted as a language model in a preset scheme; and storing the generated language model in a language model database.

### BRIEF DESCRIPTION OF THE DRAWINGS

FIG. 1 shows an apparatus of generating a language model according to an exemplary embodiment of the present invention;

FIG. 2 shows an example of a method of generating a language model using the apparatus of generating a language model of FIG. 1;

FIG. 3 shows an apparatus of generating a language model according to another exemplary embodiment of the present invention; and

FIG. 4 shows another example of a method of generating a language model using the apparatus of generating a language model of FIG. 3.

### DESCRIPTION OF EXEMPLARY EMBODIMENTS

In order to sufficiently understand the present invention, operational advantages of the present invention, and objects accomplished by exemplary embodiments of the present invention, the accompanying drawings showing exemplary embodiments of the present invention and contents described in the accompanying drawings should be referred.

Hereinafter, exemplary embodiments of the present invention will be described in detail with reference to the accompanying drawings. However, the present invention may be implemented in several different forms and is not limited to exemplary embodiments provided in the present specification. In addition, in order to clearly describe the present invention, portions that are not associated with a description will be omitted, and the same components will be denoted by the same reference numerals.

Throughout the present specification, unless explicitly described to the contrary, “comprising” any components will be understood to imply the inclusion of other elements rather than the exclusion of any other elements. A term “part”, “-er/or”, “module”, “block” or the like, described in the specification means a processing unit of at least one function or operation and may be implemented by hardware or software or a combination of hardware and software.

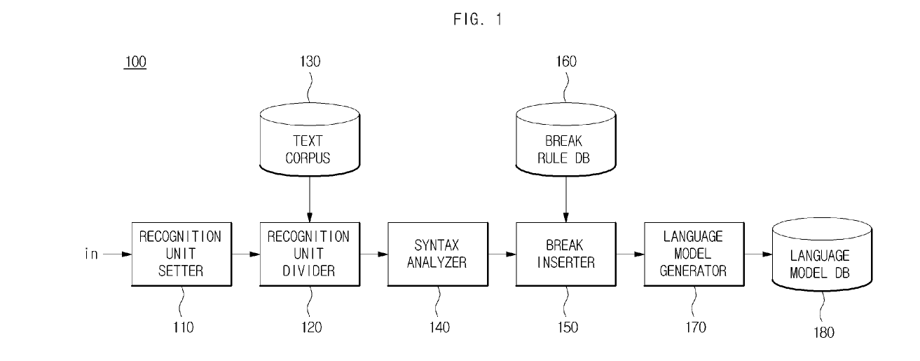

FIG. 1 shows an apparatus of generating a language model according to an exemplary embodiment of the present invention.

Referring to FIG. 1, the apparatus 100 of generating a language model according to an exemplary embodiment of the present invention is configured to include a recognition unit setter 110, a recognition unit divider 120, a text corpus 130, a syntax analyzer 140, a break inserter 150, a break rule database 160, a language model generator 170, and a language model database 180.

The recognition unit setter 110 receives a user command IN from the outside to set a recognition unit. The recognition unit may be variously set to a syllabic unit, a word unit, s separate word unit, and the like, and may be set in a form of an N-gram such as the uni-gram (1-gram), the bi-gram (2-gram), and the tri-gram (3-gram), which are recognition units for the continuous speech recognition method among the above-mentioned speech recognition methods. Hereinafter, it is assumed that the recognition unit is set to the word unit by way of example.

Although the case in which the recognition unit setter 110 receives the user command IN to set the recognition unit has been described hereinabove, the recognition unit setter 110 may also set the recognition unit using a pre-stored recognition unit without receiving the user input IN. In speech recognition, the recognition unit is hardly changed. Therefore, the recognition unit setter 110 may set the recognition unit using the pre-store recognition unit on the assumption that the recognition unit is not changed.

When the recognition unit is set, the recognition unit divider 120 obtains a text to be analyzed from the text corpus 130 and divides the obtained text based on the set recognition unit. Since it has been assumed that the recognition unit setter 110 sets the recognition unit to the word unit, the recognition unit divider 120 divides the text obtained from the text corpus 130 in the word unit. For example, in the case in which the obtained text is Korean, nouns and postpositions may be divided in the word unit, which is the recognition unit. In addition, in the case in which the obtained text is a text in which a word unit and a word spacing unit are the same as each other, such as an English text, the recognition unit setter 110 may set the recognition unit to the word spacing unit, and the recognition unit divider 120 may divide the text in the word spacing unit, which is the recognition unit.

The text corpus 130, which is a set of actual languages collected in advance for the speech recognition and samplings for the actual languages, is implemented in a form of a database. That is, the text corpus 130, which is a kind of language model database, stores language models for languages to be recognized.

The syntax analyzer 140 analyzes a syntax for the text divided in each recognition unit by the recognition unit divider 130. The syntax analyzer 140 analyzes the syntax for the text transmitted from the recognition unit divider 120 to judge a part of speech of each word in the text and a phrase and a clause configuring the text.

The break inserter 150 searches and obtains a break rule from the break rule database 160 based on a configuration of the text analyzed by the syntax analyzer 140 and adds a break mark depending on the obtained break rule. Here, the break mark may be variously set to a character, a symbol, and the like. However, in the present invention, it is assumed that, for example, “shortpause” is used as the break mark.

The break rule database 160 stores break rules corresponding to various text configurations. The break rules stored in the break rule database 160 may be created based on a break rule applied to a speech synthesizer according to the related art. The break rule has been continuously studied in order to improve naturalness and speaker's understanding of a synthetic speech as described above, and has been actually applied to and used in the speech synthesizer according to the related art. Therefore, in the present invention, the break rule previously developed and applied to the speech synthesizer is used as a break rule for improving speech recognition performance, thereby making it possible to decrease a cost required for creating the break rule.

However, since a break in the speech recognition is determined by several factors such as a grammar, a speaking style, a word length, a speaking speed, or the like, of a speaker, a break type may be different from each other from person to person even in the same text. That is, unlike speech synthesis in which a synthetic speech is generated and output, in the speech recognition, a large break difference is generated from person to person, such that it is difficult to clearly define the break. However, due to grammatical and rhythmical characteristics of a language of each nation, a position at which the break is necessarily performed is present in the text. This means that although all breaks in the text may not be accurately defined, a break in a partially limited state may be defined at a high level accuracy.

Therefore, the break rule database 160 according to an exemplary embodiment of the present invention does not use all break rules used in a speech synthesis technology, but may define break rules for only portions at which breaks are certain, in consideration of linguistic and rhythmical characteristics of the text. For example, when it is judged that persons using a language for which a language model is to be generated perform a break at a preset reference break probability (for example, 98%) or more for a specific text structure, only the judged position may be set as the break rule.

The break inserter 150 adds the break mark to the text and transmits the text to which the break mark is added to the language model generator 170. The language model generator 170 receives the text to which the break mark is added by the break inserter 150, generates the received text as a language model in a preset scheme, and stores the generated language model in the language model database 180. Here, the language model generator 170 may use tool previously developed in order to generate a language model such as the CMU Sphinx toolkit or the HMM toolkit or use another kind of language model tool corresponding to the set recognition unit.

For example, in the case in which a text “3 [symbol] [symbol] (leave New York after three days and go to Japan)” is obtained from the text corpus 130, the recognition unit divider 120 divides the text in the word unit, which is the recognition unit, that is, divides the text as “3 [symbol] [symbol] ”. Then, the syntax analyzer 140 analyzes a part of speech of each divided word and a phrase and a clause of the text to obtain a text structure. The divided text and the analyzed text structure are transmitted to the break inserter 150.

The break inserter 150 searches whether a break rule corresponding to the syntax structure is present in the break rule database 160 using the received text and text structure. The text “3 [symbol] [symbol] ” may be mainly classified to three parts, that is, “3 [symbol] ”, “ [symbol] ”, and “ [symbol] ” through a syntax analysis. In addition, when a rule instructing persons to perform a break behind a verb with respect to a text structure configured of ‘noun, postposition, verb, noun, postposition, and verb’ is stored in the break rule database 160, the break inserter 150 inserts “shortpause”, which is a break mark, between “ [symbol] ” and “ [symbol] ” so that the received text may be broken as “3 [symbol] [symbol] ” and “ [symbol] ”. That is, a text “3 [symbol] [symbol] shortpause [symbol] ” corresponding to the text into which the break is inserted is generated.

The language model generator 170 generates “3 [symbol] [symbol] shortpause [symbol] ” into which the break mark is inserted by the breaker inserter 130 as a language model and stores the generated language model in the language model database 180.

In addition, when the speech recognition is performed using the language model database 180 in which the language model into which the break mark is inserted is stored, a silent syllable that has been optionally processed or has been ignored in speech recognition according to the related art may be recognized, such that speech recognition performance may be significantly improved. However, in the case in which the speaker does not perform the break at a position corresponding to the break mark, the speech recognition performance may be deteriorated. In order to make preparations for this, in the present invention, the break marks are not inserted at all break positions, but are inserted at only break positions at which a probability at which the speaker will perform the break is equal to or higher than the reference break probability (for example, 98%), thereby improving the speech recognition performance. The reference break probability may be variously set by users. However, when the reference break probability is set to a low level of about 90%, silent syllable processing performance is improved, while a probability that an error will occur is also relatively increased. On the other hand, when the reference break probability is set to a high level of about 99.9%, the break mark may not be substantially inserted. This makes the above-mentioned break mark inserting work itself meaningless. Therefore, it is preferable that the reference break probability is selected in an experiential scheme in which an improvement rate of the speech recognition performance and an error occurrence rate are considered.

Although the language model database 180 storing the language model to which the break mark is added and the text corpus 130 have been separately shown in FIG. 1 for convenience of explanation, the apparatus 100 of generating a language model does not separately include the language model database 180 and the text corpus 130, but may replace the text obtained from the text corpus 130 by the language model generated by the language model generator 180 and store the replaced language model, since the text corpus 130 is also the language model database as described above. That is, the language model database 180 and the text corpus 130 may be integrated with each other. In addition, the language model generated by the language model generator 170 may also be additionally stored with texts pre-stored in the text corpus 130 maintained as they are.

In addition, although the recognition unit setter 110 and the recognition unit divider 120 have been separately shown in FIG. 1 for convenience of explanation, the recognition unit setter 110 and the recognition unit divider 120 may be integrated with each other. Likewise, the syntax analyzer 140 and the break inserter 150 may also be integrated with each other.

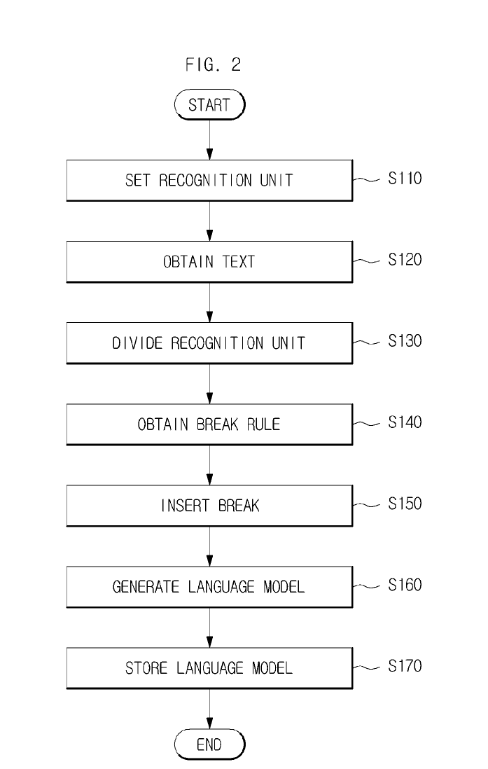

FIG. 2 shows an example of a method of generating a language model using the apparatus of generating a language model of FIG. 1.

The method of generating a language model of FIG. 2 will be described with reference to FIG. 1. First, the recognition unit setter 110 sets a recognition unit of a text (S110). As described above, the recognition unit setter 110 may receive a user command from the outside to set the recognition unit or include a recognition unit that is preset and stored.

When the recognition unit is set, the recognition unit divider 120 obtains a text to be analyzed from the text corpus 130 (S120). Then, the recognition unit divider 120 divides the obtained text in the set recognition unit (S130). The syntax analyzer 140 performs a syntax analysis on the text divided in the recognition unit, and the break inserter 150 obtains a break rule corresponding to the analyzed syntax from the break rule database (S140). Then, a break mark is inserted into the text depending on the obtained break rule (S150). The text into which the break rule is inserted is generated as a language model by the language model generator 170 (S160). The generated language model is stored in the language model database 180 (S170). Here, only the language model into which the break mark is inserted may be stored in the language model database 180 or the language model into which the break mark is inserted may be stored, together with the text divided in the recognition unit by the recognition unit divider 120, in the language model database 180.

For example, “ [symbol] [symbol] ”, which is the text divided in the recognition unit, and “3 [symbol] [symbol] shortpause [symbol] ”, which is the text into which break mark is inserted, may be matched to each other and be stored in the language model database 180.

When the language model generated from the text into which the break mark is inserted and the text divided in the recognition unit by the recognition unit divider 120 are stored together in the language model database 180, there is an advantage that it is possible to cope with both of the case in which a speaker performs a break on a portion at which the break mark is inserted and the case in which a speaker does not perform the break on the portion, at the time of performing the speech recognition. However, in the present invention, since the break marks are not inserted at all break positions, but are inserted at only break positions at which a probability at which the speaker will perform the break is equal to or higher than the reference break probability, when the reference break probability is sufficiently high, the text that does not have the break mark inserted thereinto and is divided in the recognition unit is unnecessary data and increases only a size of the language model, which is disadvantageous. Therefore, it is very important to appropriately set the reference break probability by an experiential or experimental method.

Meanwhile, in order to minimize a disadvantage that a size of the language model is increased when the language model generated from the text into which the break mark is inserted and the text divided in the recognition unit are stored together in the language model database 180, only a syntax at a position at which the break mark is inserted rather than an entire text into which the break mark is inserted may be stored, together with the text divided in the recognition unit, in the language model database 180. For example, “3 [symbol] [symbol] ” and “ [symbol] shortpause [symbol] ” may be matched to each other and be stored in the language model database 180.

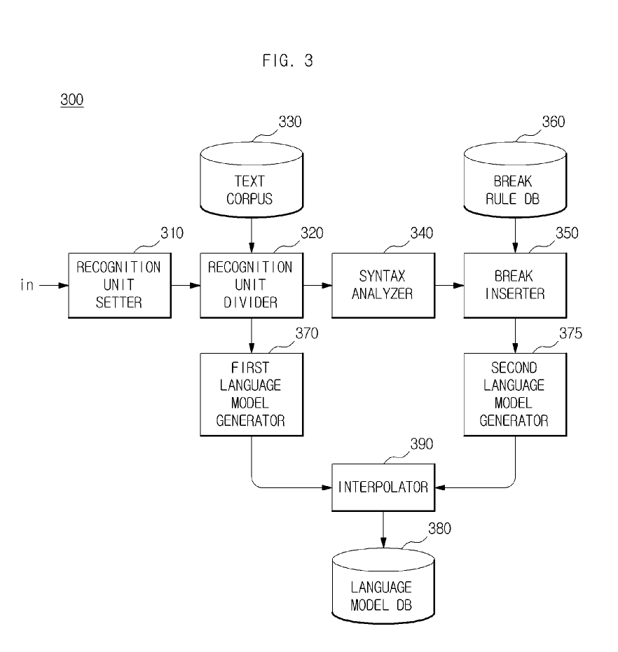

FIG. 3 shows an apparatus of generating a language model according to another exemplary embodiment of the present invention.

The apparatus 300 of generating a language model of FIG. 3 is configured to include a recognition unit setter 310, a recognition unit divider 320, a text corpus 330, a break inserter 350, a break rule database 360, a first language model generator 370, a second language model generator 375, an interpolator 390, and a language model database 380. Since the recognition unit setter 310, the recognition unit divider 320, the text corpus 330, the break inserter 350, the break rule database 360, and the language model database 380 of the apparatus 300 of generating a language model of FIG. 3 are the same as the recognition unit setter 110, the recognition unit divider 120, the text corpus 130, the break inserter 150, the break rule database 160, and the language model database 180 of the apparatus 100 of generating a language model of FIG. 1, respectively, a description thereof will be omitted in FIG. 3.

In addition, the first language model generator 370 and the second language model generator 375 of FIG. 3 correspond to the language model generator 170 of FIG. 1. However, as shown in FIG. 3, the language model generator includes two separate language model generators, that is, the first language model generator 370 and the second language model generator 375. In FIG. 1, one language model generator 170 generates the text into which the break mark is inserted and the text divided in the recognition unit as the language model. In addition, the generated language model is stored in the language model database 180 as it is. However, in the apparatus 300 of generating a language model of FIG. 3, the first language model generator 370 generates the text divided in the recognition unit by the recognition unit divider 320 as a first language model, and the second language model generator 375 generates the text into which the break mark is inserted by the break inserter 350 as a second language model.

The interpolator 390, which is additionally included in the apparatus 300 of generating a language model of FIG. 3 unlike the apparatus 100 of generating a language model of FIG. 1, receives the first language model from the first language model generator 370, receives the second language model from the second language model generator 375, and interpolates the first and second language models. In addition, a language model generated through the interpolation is stored in the language model database 380. A method of interpolating the first and second language models may be variously set. As an example, a method of allowing a break mark position of the second language model into which the break mark is inserted to be included in the first language model, which is the text divided in the recognition unit, may be used. In this case, only information on a position at which the break is to be marked is stored additionally in the language model database 380 in a state in which the first language model that is the same as a language model used in speech recognition according to the related art is maintained as it is, thereby making it possible to increase flexibility of the speech recognition and minimize a size of the language model.

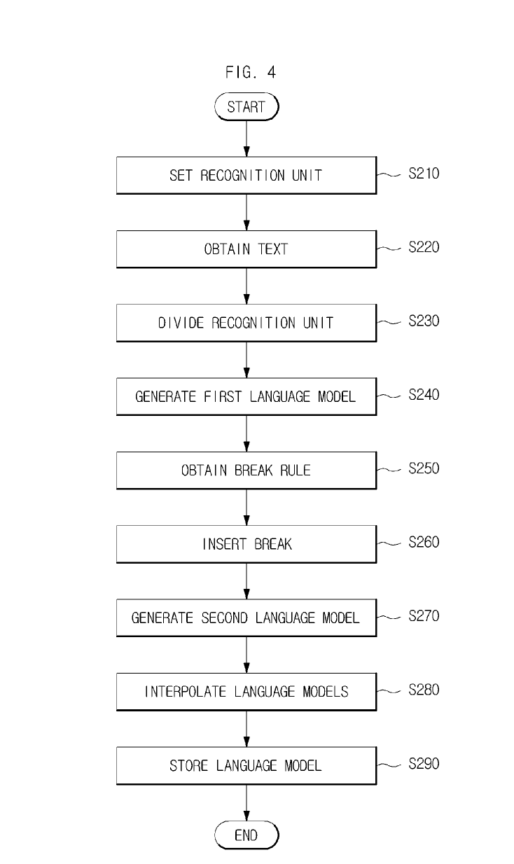

FIG. 4 shows another example of a method of generating a language model using the apparatus of generating a language model of FIG. 3.

In the method of generating a language model of FIG. 4, the recognition unit setter 310 first sets a recognition unit of a text (S210). Then, the recognition unit divider 320 obtains a text to be analyzed from the text corpus 330 (S220). Then, the recognition unit divider 120 divides the obtained text in the set recognition unit (S230). When the text is divided in the recognition unit, the first language model generator 370 of the apparatus 300 of generating a language model of FIG. 3 generates the text divided in the recognition unit as a first language model (S240). Meanwhile, the syntax analyzer 340 performs a syntax analysis on the text divided in the recognition unit, and the break inserter 350 obtains a break rule corresponding to the analyzed syntax from the break rule database (S250). Then, a break mark is inserted into the text depending on the obtained break rule (S260). The text into which the break rule is inserted is generated as a second language model by the second language model generator 170 (S270). Next, the interpolator 390 receives and interpolates the first and second language models (S280). Then, a language model generated through the interpolation is stored in the language model database 380 (S290).

Although the case in which the apparatus 300 of generating a language model includes the first and second language model generators 370 and 375 and the interpolator 390 has been shown in FIG. 3 for convenience of explanation, the language model generator 170 of FIG. 1 may be implemented to perform all of the operations of the first and second language model generators 370 and 375 and the interpolator 390.

As described above, in the apparatus and the method of generating a language model according to an exemplary embodiment of the present invention, break information that is already generated and is already used in a method of generating a synthetic speech is applied to the language model for the speech recognition in order to improve a speech recognition method according to the related art of optionally recognizing or ignoring a silent syllable corresponding to a break to cause performance deterioration Particularly, the break mark is inserted at only a portion at which the break is performed at a high probability depending on characteristics of a language to generate the language mode, thereby making it possible to predict a position of a silent syllable corresponding to the break in the language model. Therefore, a speech recognizer may easily detect the silent syllable at the time of performing the speech recognition.

Accordingly, in the apparatus and the method of generating a language model according to an exemplary embodiment of the present invention, break information that is already generated and is already used in a method of generating a synthetic speech is applied to the language model for the speech recognition in order to improve a speech recognition method according to the related art of optionally recognizing or ignoring a silent syllable corresponding to a break to cause performance deterioration Therefore, since a position of a silent syllable corresponding to the break in the language model may be predicted without separately generating break information, a speech recognizer may easily detect the silent syllable at the time of performing the speech recognition. As a result, speech recognition performance may be significantly improved at a low cost.

The method of generating a language model according to an exemplary embodiment of the present invention may be implemented as a computer readable code in a computer readable recording medium. A computer readable recording medium may include all kinds of recording apparatuses in which data that may be read by a computer system are stored. An example of the computer readable recording medium may include a read only memory (ROM), a random access memory (RAM), a compact disk read only memory (CD-ROM), a magnetic tape, a floppy disk, an optical data striate, or the like, and also include a medium implemented in a form of a carrier wave (for example, transmission through the Internet). In addition, the computer readable recording mediums may be distributed in computer systems connected to each other through a network, such that computer readable codes may be stored and executed in computer readable recording mediums in a distributed scheme.

Although the present invention has been described with reference to exemplary embodiments shown in the accompanying drawings, it is only an example. It will be understood by those skilled in the art that various modifications and equivalent other exemplary embodiments are possible from the present invention.

Accordingly, an actual technical protection scope of the present invention is to be defined by the following claims.

What is claimed is:

1. An apparatus of generating a language model, comprising:
a text corpus in which a plurality of texts collected in advance for speech recognition are stored;
a recognition unit divider obtaining at least one of the plurality of texts from the text corpus and dividing the obtained text in a preset recognition unit;
a syntax analyzer analyzing a syntax of the text divided in the recognition unit;
a break rule database in which a plurality of break rules set based on a preset break rule for speech synthesis are pre-stored;
a break inserter searching and obtaining a corresponding break rule among the plurality of break rules using the syntax analyzed by the syntax analyzer and inserting a preset break mark into the text divided in the recognition unit depending on the obtained break rule;
a language model database in which language models are stored; and
a language model generator receiving the text into which the break mark is inserted by the break inserter, generating the received text as a language model in a preset scheme, and storing the generated language model in the language model database.

2. The apparatus of generating a language model of claim 1, wherein the break rule database stores a break rule in which a probability at which a speaker actually performs a break is equal to or higher than a reference break probability experimentally set among the plurality of break rules set based on the preset break rule for the speech synthesis.

3. The apparatus of generating a language model of claim 1, wherein the language model generator converts both of the text into which the break mark is inserted and the text divided in the recognition unit into the language model and stores the language model in the language model database.

4. The apparatus of generating a language model of claim 1, wherein the language model generator stores the break mark and a preset number of words before and after the break mark in the text into which the break mark is inserted and the text divided in the recognition unit in the language model database.

5. The apparatus of generating a language model of claim 1, wherein the text corpus is implemented as the same database as the language model database.

6. The apparatus of generating a language model of claim 1, further comprising: a recognition unit setter receiving a user command from the outside, setting the recognition unit in response to the received user command, and transmitting the set recognition unit to the recognition unit divider.

7. The apparatus of generating a language model of claim 1, wherein the language model generator includes:
a first language model generator receiving the text divided in the recognition unit from the recognition unit divider and generating a first language model;
a second language model generator receiving the text into which the break mark is inserted from the break inserter and generating a second language model; and
an interpolator interpolating the first and second language models to generate the language model and storing the generated language model in the language model database.

8. The apparatus of generating a language model of claim 7, wherein the interpolator comparing the first and second language models with each other and inserting information on a position at which the break mark is inserted from the second language model into the first language model.

9. A method of generating a language model by an apparatus of generating a language model including a text corpus in which a plurality of texts collected in advance for speech recognition are stored and a break rule database in which a plurality of break rules set based on a preset break rule for speech synthesis are pre-stored, comprising:
obtaining at least one of the plurality of texts from the text corpus;
dividing the obtained text in a preset recognition unit;
analyzing a syntax of the text divided in the recognition unit and searching and obtaining a corresponding break rule among the plurality of break rules using the analyzed syntax;
inserting a preset break mark into the text divided in the recognition unit depending on the obtained break rule;
generating the text into which the break mark is inserted as a language model in a preset scheme; and
storing the generated language model in a language model database.

10. The method of generating a language model of claim 9, wherein the break rule database stores a break rule in which a probability at which a speaker actually performs a break is equal to or higher than a reference break probability experimentally set among the plurality of break rules set based on the preset break rule for the speech synthesis.

11. The method of generating a language model of claim 9, wherein in the generating of the text into which the break mark is inserted as the language model, the text divided in the recognition unit is also generated as the language model.

12. The method of generating a language model of claim 11, wherein in the storing of the generated language model in the language model database, both of the text into which the break mark is inserted and the text divided in the recognition unit are stored in the language model database.

13. The method of generating a language model of claim 11, wherein in the storing of the generated language model in the language model database,
the break mark and a preset number of words before and after the break mark in the text into which the break mark is inserted and the text divided in the recognition unit are stored in the language model database.

14. The method of generating a language model of claim 9, wherein the generating of the text into which the break mark is inserted as the language model includes:
receiving the text divided in the recognition unit and generating a first language model;
receiving the text into which the break mark is inserted and generating a second language model; and
interpolating the first and second language models to generate the language model.

15. A recording medium in which a computer readable program for performing the method of generating a language model of claim 9 is recorded.
